(19) United States
(12) Patent Application Publication
(10) Pub. No.: US 2019/0009496 A1
(43) Pub. Date: Jan. 10, 2019

(54) TEXTURED, BREATHABLE TEXTILE LAMINATES AND GARMENTS PREPARED THEREFROM

(71) Applicants: W. L. Gore & Associates GmbH, Putzbrunn (DE); W. L. Gore & Associates, Inc., Newark (DE)

(72) Inventors: John E. Trouba, Avondale, PA (US); Martin Hottner, Bruckmuehl (DE); Birgit Schaldecker, Feldkirchen-Westerham (DE)

(21) Appl. No.: 16/066,831

(22) PCT Filed: Feb. 3, 2017
(86) PCT No.: PCT/US2017/016340

§ 371 Date: Jun. 28, 2018

Related U.S. Application Data
(60) Provisional application No. 62/290,788, filed on Feb. 3, 2016.

(51) Int. Cl. B32B 3/28; B32B 27/32; B32B 5/02; B32B 3/30; B32B 27/12; A41D 31/02; A41B 17/00; A41B 1/08; A41D 3/00; A41D 19/00; A41D 1/06; A42B 1/00

(52) U.S. Cl. CPC B32B 3/28; B32B 2255/10; B32B 5/026; B32B 3/30; B32B 27/12; A41D 31/02; A41B 17/00; A41B 1/08; A41D 3/00; A41D 19/0006; A41D 1/06; A42B 1/00; B32B 2262/0276; B32B 2307/554; B32B 2307/724; B32B 2307/73; B32B 2437/00; A41D 2400/22; A41B 2400/22; A41D 2500/20; A41D 2500/30; B32B 27/322

(57) ABSTRACT

A textile laminate as described herein comprises a water vapor permeable outward facing protective membrane comprising an inner surface and an outer surface and a textile attached to the inner surface of the membrane, wherein the textile has a surface having a pattern of high regions and low regions. The outer surface of the membrane has a surface topography comprising a pattern of high and low regions that are dimensionally coordinated with a pattern of high and low regions on the surface of the textile.

### PRIORITY CLAIM

This patent application claims priority from U.S. Provisional App. No. 62/290,788, filed Feb. 3, 2016, the disclosure of which are incorporated herein by reference in its entirety.

### FIELD OF THE INVENTION

Described herein is a textured, breathable textile laminate having a permeable membrane with an outer surface that is exposed to the environment. In addition, there is provided a lightweight durable article of apparel, such as a garment, made from the textured, breathable textile laminate described herein.

### BACKGROUND

Articles of apparel having permeable membranes for providing water resistance or liquidproofness, while simultaneously providing breathability are known. Laminates and garments are constructed to provide protection to the membranes so as to resist tearing, damage by puncture or abrasion, and the like. Inner and outer fabric layers are most frequently added to both surfaces of the membrane to protect the membrane surface from damage.

Garments having a permeable membrane surface uncovered by a protective inner or outer layer of fabric are often constructed for use in combination with another garment having a fabric surface. The fabric surface of the additional garment provides protection to the membrane against damage. For example, an undergarment comprising a membrane lacking an outer protective fabric layer is constructed to be used under a separate outer garment where it is less susceptible to sustaining direct damage. Thus, the membrane in these undergarments is not exposed to the environment. The addition of outer and inner fabric layers required to protect the permeable membrane from damage adds weight to an article of apparel and results in materials having a higher water pickup on the outer surface. Moreover, wearing an outerwear garment to protect an undergarment having an outward facing membrane forms a bulky ensemble.

Multi-layered garments are constructed to provide properties desired by consumers. For example, garments are designed with layers of textiles and/or membranes to impart abrasion resistance, breathability, tear resistance, puncture resistance, water resistance, and the like to the garments. Garments including outward facing permeable membranes are particularly beneficial, as such membranes provide desirable abrasion-, pilling-, and liquid-proof properties. However, such garments are visually unappealing to consumers desiring a textile-appearing product.

FIG. 1 illustrates a conventional laminate 10 having an outer facing permeable membrane 1 with a flat surface 3. An underlying textile 2 has a surface topography 4 of high regions 5 and low regions 6. This flat surface 3 of the conventional laminate 10 does not resemble the topography of the textile and consumers may not perceive the material as being of a high quality or aesthetically pleasing. Such conventional laminates are further described in U.S. Pat. No. 5,155,867.

One solution proposed to overcome this problem is casting or fusing the textile into a film with a textile like structure. WO2015/100369 discloses a textile construct with a performance film formative built into a textile structure. The textile construct needs only to be subject to a fusing agent to cause the performance film formative to convert from its lattice structure (e.g., knit or woven structure) into a film that is built into a retained lattice structure of the textile. More particularly, the formation of the textile construct is based on fusion of selected filaments, e.g., thermoplastic fibers or yarns, to selectively create a film on one side or layer in the construct while substantially preserving the lattice structure of an opposing side or adjacent layer of non-fusible filaments in a lattice structure. This creates a hybrid film/lattice textile construct. Both open-faced and sandwiched constructions of the film in a unitary structure with the retained lattice structure of another side or layer(s) are possible.

Other known garments having outer facing membranes also have abrasion resistance, breathability, tear resistance, puncture resistance, and water resistance properties. U.S. Pat. No. 9,084,447 describes laminates having a durable outer film surface for use in making lightweight liquidproof articles, including articles of apparel, such as outerwear garments. A method of making the laminate and a lightweight outerwear garment having an abrasion resistant exterior film surface is also described.

U.S. Pat. No. 8,163,662 discloses a lightweight enclosure having an exterior film surface. The lightweight enclosure comprises a laminate having a porous outer membrane. The laminate is moisture vapor transmissive and flame resistant (passing CPAI-84), and abrasion resistant on the outer film surface thereby remaining durably liquidproof. The lightweight enclosure may be a single wall tent and is formed from a laminate having sufficient oxygen permeability to sustain life while enclosure openings are closed.

Other attempts have been made to modify the outer surface of the porous membrane by adding textures, such as adhesive dots, as described in US Pub. No. 2009/0089911.

Continued efforts are needed, however, to provide the desired properties, such as abrasion resistance, breathability, tear resistance, puncture resistance, and/or water resistance properties, for garments and/or laminates while having an outward facing permeable membrane, all while being visually appealing to consumers as a textile appearing product.

### SUMMARY OF THE INVENTION

In one embodiment, the invention is directed to a textile laminate, comprising a water vapor permeable outward facing protective membrane comprising an inner surface and an outer surface; and a textile attached to the inner surface of the permeable membrane, wherein the textile has a surface having a pattern of high regions and low regions, wherein the outer surface of the permeable membrane has a surface topography that is dimensionally coordinated with the pattern of high regions and low regions on the surface of the textile, and wherein said dimensional coordination occurs with an H/V ratio of greater than or equal to 0.5, e.g., greater than or equal to 1, wherein the H/V ratio is defined by the horizontal displacement (H) between adjacent high and low regions to the vertical displacement (V) between a peak in the high region and a valley in the adjacent low region on the outer surface of the permeable membrane. In one embodiment, the total of the individual straight line displacements from the permeable membrane surface is within 20%, within 15% or within 10%, of the length of the total of the individual displacements on the corresponding textile surface. In one embodiment, the permeable membrane has a substantially uniform thickness. In some embodiments, the permeable membrane is not embossed. In one embodiment, the permeable membrane comprises a porous membrane, such as polytetrafluoroethylene, expanded polytetrafluoroethylene, polyurethane, copolyetherester, polyolefins, polyesters, or a combination thereof. In another embodiment, the permeable membrane comprises a monolithic membrane, such as polyurethane, polyether-polyester, or a combination thereof.

In another embodiment, the invention is directed to a textile laminate, comprising a water vapor permeable outward facing protective membrane comprising an inner surface and an outer surface; and a knitted textile attached to the inner surface of the membrane, wherein the knitted textile has a surface having a repeating pattern of high regions and low regions, wherein the outer surface of the permeable membrane has a surface topography that is dimensionally coordinated with the repeating pattern of high regions and low regions on the surface of the knitted textile, and wherein said dimensional coordination occurs with an H/V ratio of greater than or equal to 0.5, e.g., greater than or equal to 1, wherein the H/V ratio is defined by the horizontal displacement (H) between adjacent high and low regions to the vertical displacement (V) between a peak in the high region and a valley in the adjacent low region on the outer surface of the permeable membrane. In one embodiment, the permeable membrane has a substantially uniform thickness. In some embodiments, the permeable membrane is not embossed.

In another embodiment, the invention is directed to a textile laminate, comprising a water vapor permeable outward facing protective membrane comprising an inner surface and an outer surface; and a woven textile attached to the inner surface of the permeable membrane, wherein the textile has a surface having a repeating pattern of high regions and low regions, wherein the outer surface of the permeable membrane has a surface topography that is dimensionally coordinated with the repeating pattern of high regions and low regions on the surface of the woven textile, and wherein said dimensional coordination occurs with an H/V ratio of greater than or equal to 0.5, e.g., greater than or equal to 1, wherein the H/V ratio is defined by the horizontal displacement (H) between adjacent high and low regions to the vertical displacement (V) between a peak in the high region and a valley in the adjacent low region on the outer surface of the permeable membrane. In one embodiment, the permeable membrane has a substantially uniform thickness. In some embodiments, the permeable membrane is not embossed.

In another embodiment, the invention is directed to a textile laminate, textile laminate, comprising a water vapor permeable outward facing protective membrane comprising an inner surface and an outer surface, and a non-woven textile attached to the inner surface of the permeable membrane, wherein the non-woven textile has a surface having a repeating or a non-repeating pattern of high regions and low regions, wherein the outer surface of the permeable membrane has a surface topography that is dimensionally coordinated with the repeating or the non-repeating pattern of high regions and low regions on the surface of the non-woven textile, and wherein said dimensional coordination occurs with an H/V ratio of greater than or equal to 0.5, e.g., greater than or equal to 1, wherein the H/V ratio is defined by the horizontal displacement (H) between adjacent high and low regions to the vertical displacement (V) between a peak in the high region and a valley in the adjacent low region on the outer surface of the permeable membrane. In one embodiment, the permeable membrane has a substantially uniform thickness. In some embodiments, the permeable membrane is not embossed.

In yet another embodiment, the invention is directed to a garment (shirt, pants, glove, shoe, hat, or jacket) constructed from a textile laminate, the textile laminate, comprising a water vapor permeable outer facing protective membrane (the outer facing surface is exposed to the environment external to the wearer) comprising an inner surface and an outer surface; and a textile attached to the inner surface of the permeable membrane, wherein the textile has a surface having a pattern of high regions and low regions, wherein the outer surface of the permeable membrane has a surface topography that is dimensionally coordinated with the pattern of high regions and low regions on the surface of the textile, and wherein said dimensional coordination occurs with an H/V ratio of greater than or equal to 0.5, e.g., greater than or equal to 1, wherein the H/V ratio is defined by the horizontal displacement (H) between adjacent high and low regions to the vertical displacement (V) between a peak in the high region and a valley in the adjacent low region on the outer surface of the permeable membrane. In other embodiments, the garment may comprise at least one region constructed of the textile laminate and that region may be a shoulder portion, an elbow portion, a knee portion, or a sleeve portion.

It would be appreciated by one of skill in the art that multiple combinations of the embodiments described herein are within the scope of the present invention.

### BRIEF DESCRIPTIONS OF FIGURES

The advantages of this invention will be apparent upon consideration of the following detailed disclosure of the invention, especially when taken in conjunction with the accompanying drawings wherein:

FIG. 1 is a known laminate having an outer facing permeable membrane having a flat surface.

FIG. 2 is a schematic illustration of a laminate having a surface topography that is dimensionally coordinated with the surface of the underlying textile according to one exemplary embodiment of the invention.

FIG. 3 is a schematic illustration of a laminate having two permeable membranes with at least one of the permeable membranes having a surface topography that is dimensionally coordinated with the surface of an underlying textile according to one exemplary embodiment of the invention.

FIG. 4A is a picture of a knit textile surface having a pattern of high regions and low regions and FIG. 4B is a picture of outer surface of the permeable membrane that is dimensionally coordinated with the surface of an underlying textile according to one exemplary embodiment of the invention. FIG. 4C is a picture of an open knitted surface having a pattern of high regions and low regions and FIG. 4D is a picture of outer surface of the permeable membrane that is dimensionally coordinated with the surface of an underlying textile according to one exemplary embodiment of the invention.

FIG. 5A is a photograph of the textile surface according to Example 1. FIG. 5B is a photograph of the permeable membrane outer surface of the laminate according to Example 1. FIG. 5C shows a scanning electron micrograph (SEM) cross section of the laminate according to Example 1.

FIG. 6 is a photograph of the undulating textile surface of a further example of a textile with high and low regions.

FIG. 7A is a photograph of the textile surface of the laminate according to Example 2. FIG. 7B is a photograph of the permeable membrane outer surface of the laminate according to Example 2. FIG. 7C shows a scanning electron micrograph (SEM) cross section of the laminate according to Example 2.

FIG. 8A is a photograph of the textile surface and permeable membrane outer surface of the laminate according to Example 3. FIG. 8B is a photograph of the textile surface of the laminate according to Example 3. FIG. 8C shows a scanning electron micrograph (SEM) cross section of the laminate according to Example 3.

FIG. 9A is a picture of the textile surface of the laminate according to Comparative Example A as viewed with a surface measuring device. FIG. 9B is a picture of the flat surface of permeable membrane according to Comparative Example A as viewed with a surface measuring device.

FIG. 10A is a photograph of the laminate according to Comparative Example B.

FIG. 10B shows a scanning electron micrograph (SEM) cross section of the laminate according to Comparative Example B.

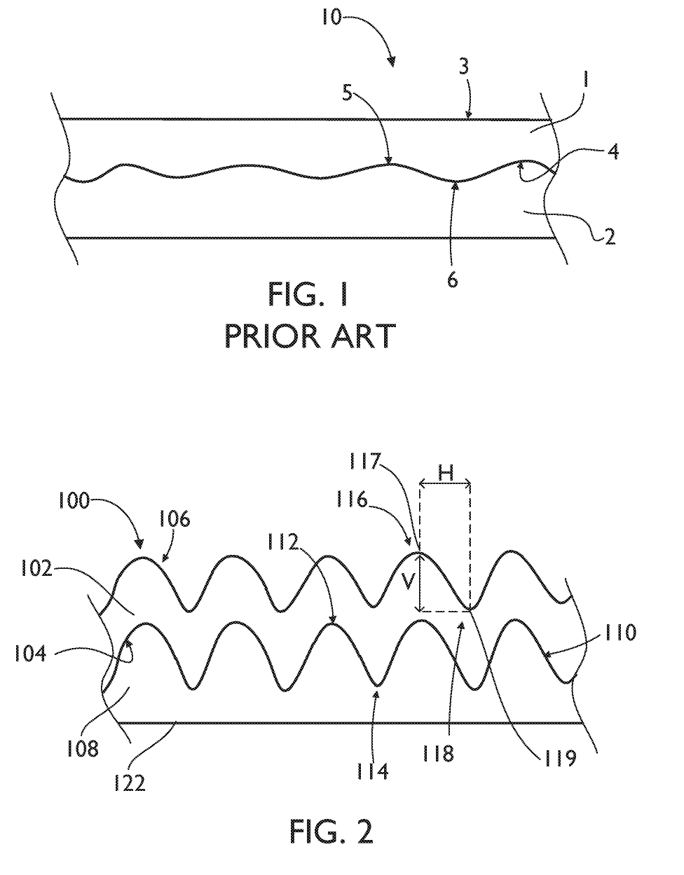

### DETAILED DESCRIPTION OF THE INVENTION

Embodiments of the present invention relate to a textured, breathable textile laminate comprising a water vapor permeable outward facing protective membrane having a surface topography that is dimensionally coordinated with the surface of an underlying textile. The textile may have a pattern of high and low regions on the surface. This pattern is dimensionally coordinated with high and low regions on the outer membrane surface such that the texture of the outer permeable membrane has an appearance of being a textile. The disclosed textile laminate provides these attributes without sacrificing water vapor permeability and can be used as an outer surface of a garment or apparel with the permeable membrane being outwardly facing from the wearer such apparel having advantages including but not limited to low water pick up of the outer surface material and light weight. Advantageously, the garment or a specific region of the garment has the desirable aesthetic appearance of a textile surface while providing the benefits of an outer facing permeable membrane and the underlying textile is not visible or exposed to the environment.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein.

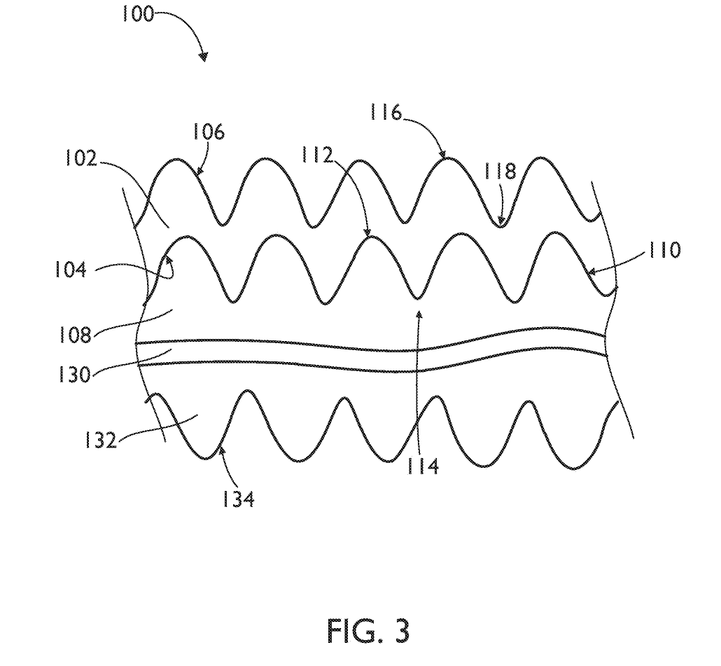

Reference is made to FIG. 2, which illustrates a textile laminate 100 comprising a permeable membrane 102 having an inner surface 104 and an outer surface 106. As described herein permeable membrane 102 may be a monolithic membrane or porous membrane. A textile 108 is attached to the inner surface 104. Textile 108 is selected to provide dimensional stability to the permeable membrane when formed as a laminate 100. Textile 108 attached to inner surface 104 of permeable membrane 102 may be formed of a woven, knit, or non-woven material, and it may be comprised of materials such as, but not limited to, cotton, rayon, nylon, polyester, polyamides, and blends thereof. In one embodiment, textile may be formed of a woven or knit material. The term “woven” may include any textile structure made up with weft and warp yarns, fibers, or filaments. The term “knit” or “knitted” is to be understood broadly, in particular including any forms of warp knits and circular knits, but also covering any other configurations where a textile structure is produced by wrapping one or more yarns, fibers, or filaments such as to form loops. Thus, a knit as used herein may also cover configurations that might be referred to as braided structures. In the case of a garment, the textile can also be selected to provide a comfortable feel on the side of the laminate oriented towards the wearer. The weight of the textile forming the textile 108 is not particularly limited except as required by the application. In some applications, the textile can have a weight of not greater than 340 g/m² (about 10 oz/yd²), or not greater than 275 g/m², or not greater than 200 g/m², or not greater than 100 g/m², or not greater than 50 g/m². In one embodiment, the textile may be air permeable.

Any suitable process for attaching permeable membrane 102 and textile 108 may be used, such as lamination, fusion bonding, spray adhesive bonding, and the like. When using an adhesive, the adhesive may be applied discontinuously or continuously, provided that breathability or permeation through the laminate is maintained. Adhesive compositions include thermoset adhesives, such as polyurethane, and silicone. For example, the adhesive may be applied in the form of discontinuous attachments, such as by discrete dots, or in the form of an adhesive web to adhere permeable membrane 102 and textile 108 together.

Textile 108 has a surface 110 comprising high regions 112 and low regions 114. Depending on the type of textile, fibers of the textile may create the high regions 112 and low regions 114 due to, for example, the knitting, and/or weaving pattern of the fibers. In an open net knit textile the low regions may be the openings in the net. It should be understood that depending on the surface topography there may also be several intermediate regions. However, to achieve the desirable aesthetic appearance, according to embodiments of the present invention, permeable membrane 102 is dimensionally coordinated to the pattern of high regions 112 and low regions 114. In further embodiments, the permeable membrane may also be dimensionally coordinated to the intermediate regions.

In one embodiment, the surface topography of textile 108 may comprise a pattern of high regions 112 and low regions 114, and in an alternative embodiment the surface topography may comprise repeating pattern. For example, the knit and woven material may have a repeating pattern and non-woven materials may have a repeating pattern or non-repeating pattern. Dimensionally coordinating the pattern of the textile on the outer surface of the permeable membrane may advantageously provide a more textile-like looking laminate and/or garment.

Depending on the type of textile, the vertical displacement from the high region 112 to an adjacent low region 114 may be greater than or equal to 10 micrometers (μm), greater than or equal to 15 μm or greater than or equal to 400 μm. Vertical displacement is determined by the difference in height between adjacent peaks and valley in the high and low regions. Vertical displacement along an axis perpendicular to laminate 100 and is measured from the highest part of the high regions 112 to lowest part of the low region 114. To account for slight variations in the pattern an average vertical displacement may be used. In terms of ranges, the vertical displacement from the high region 112 to the lower region 114 may range from 10 μm to 600 μm, from 10 μm to 500 μm, from 10 μm to 400 μm, from 10 to 300 μm, or from 10 μm to 200 μm.

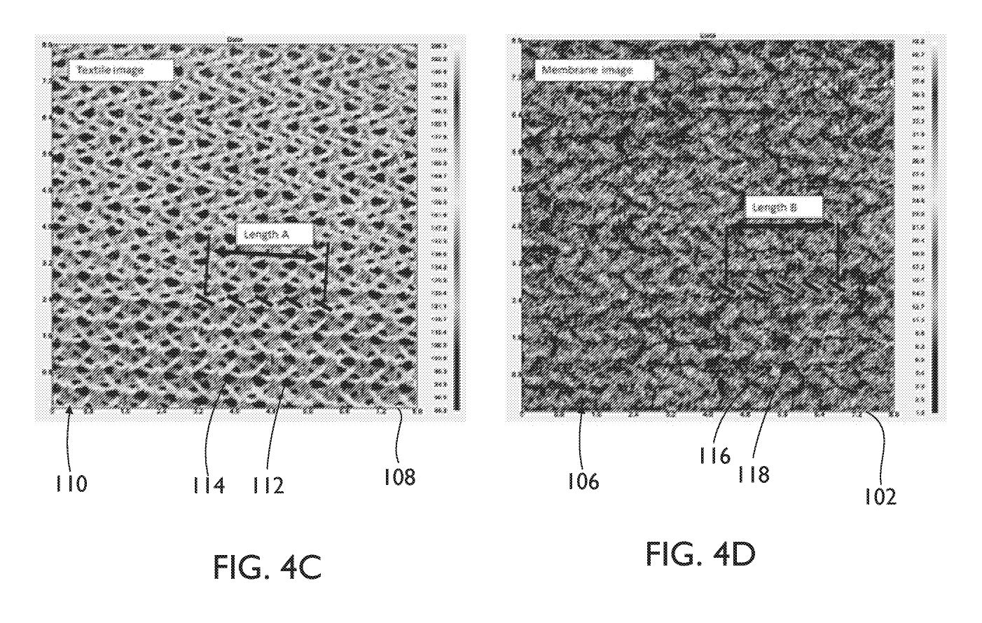

To resemble the appearance of textile 108, the permeable membrane 102 is dimensionally coordinated with the pattern of high regions 112 and low regions 114 of the surface of the textile 108. A dimensionally coordinated permeable membrane also comprises high regions 116 and low regions 118. The terms “dimensionally coordinated” and “dimensional coordination,” and the like, refer to the outer surface having a topography that corresponds to the high regions and/or low regions on the surface of the textile. As shown in FIGS. 4A and 4B, the low regions 112 (circled) on surface 110 of textile 108 in FIG. 4A corresponds to the low regions 118 on outer surface 106 of permeable membrane 102 in FIG. 4B, thus forming a textured surface for textile laminate 100. Similarly for an open-net knit shown in FIGS. 4C and 4D, the low regions 112 are the openings in textile 108 and high regions 114 are the intersections of the knit that correspond to the high regions 116 on outer surface 106 of permeable membrane 102 in FIG. 4D, thus forming a textured surface for textile laminate 100.

In one embodiment, a ratio of horizontal displacement (H) to vertical displacement (V) of peaks and valleys in adjacent high and low regions on the outer surface is measured. The H/V ratio may be used compare the surface of the textile to the outer surface of the permeable membrane. In one embodiment, the H/V ratio in greater than or equal to 0.5, greater than or equal to 1, greater than or equal to 1.5 or greater than or equal to 2. Stated differently, in some embodiments, the horizontal displacement (H) between adjacent high and low regions is greater than or equal to the vertical displacement (V) between adjacent peaks and valleys. In terms of ranges, the H/V ratio may be from 0.5 to 100, from 1 to 100, from 1 to 50 or from 1 to 20. Having an H/V ratio of greater than 100 is not desirable because the outer surface may appear smooth or texture-less, and thus not having a visual appearance of a textile. The dimensional coordination is determined by choosing a number of adjacent high or low regions on both the textile surface and outer surface of the permeable membrane, such as five adjacent low regions. It should be understood that any number (from 5 to 100) of high or low regions may be selected provided that the same number of high or low regions is measured on both the textile surface and the permeable membrane outer surface. If low regions are chosen as shown in FIG. 4A, at least one straight line (or a series of lines) is drawn through the centers of the low regions 112 on the textile 108 to obtain the total cumulative displacement length (A). For purposes of best fit correlation of the features or regions of the textile with those of the permeable membrane, the lines are drawn within an area (shown by the square). The area should be sufficiently sized to capture at least 5 corresponding high or low regions being compared between the textile and permeable membrane. Within the similar area on the permeable membrane 102, another line or series of lines in a similar pattern to those on the textile and of total cumulative displacement length (B) are drawn through the centers of the same number of low regions 118. In one embodiment, dimensionally coordinated of the total of the individual straight line displacements from the permeable membrane surface (displacement length of line (B)) is within 20% (i.e. +/−20%), within 15% or within 10%, of the length of the total of the individual displacements on the corresponding textile surface (displacement length of line (A)). Stately differently, dimensionally coordinated of the total of the individual straight line displacements through the centers of a set number of adjacent and corresponding high and/or low regions on the permeable membrane outer surface area is within 20%, within 15% or within 10%, of the total of the individual straight line displacements through the centers of the set number of corresponding and adjacent features on the corresponding textile surface area. When the total displacement varies greatly (more than 20%) then the outer surface of the permeable membrane does not resemble the underlying textile.

As described above, the surface topography of the textile may have a repeating pattern of high regions and low regions. When the permeable membrane is dimensionally coordinated with the pattern of high regions and low regions on the surface of the textile, the repeating pattern may be readily detectable on the outer surface of the permeable membrane. This further gives the textile laminate or garment constructed from the textile laminate a desirable aesthetic appearance.

An interior surface of textile 108 may have a surface topology that is similar or different from surface 110. Interior surface 122 may be worn against the wearer and may be exposed to moisture from the wearer, but is not exposed to the environment.

The textile laminates described herein are breathable and have a moisture vapor transmission rate (MVTR) that is greater than or equal to 1000 g/m²/24 hours, greater than or equal to 5000 g/m²/24 hours, greater than or equal to 10,000 g/m²/24 hours, greater than or equal to 15,000 g/m²/24 hours, greater than or equal to 20,000 g/m²/24 hours, greater than or equal to 25,000 g/m²/24 hours, or greater than or equal to 30,000 g/m²/24 hours when tested according to the MVTR Test Method described herein. Having a high MVTR increases the perceived comfort to the wearer.

As described herein, permeable membrane 102 is outer facing so that the permeable membrane is exposed to moisture, rain, light, and air. In other words, the outer facing permeable membrane is exposed to the environment. When the laminate is used as a garment, the outer facing permeable membrane 102 is visible. In particular, the outer surface 106 is visible. Conversely, the textile 108 is not exposed to the environment and is not visible. Due to the visibility of the permeable membrane 102 it is advantageous that outer surface 106 resemble the surface topography of a textile in order to increase wearer acceptance for the garment or apparel.

One advantage of having the outer facing permeable membrane resembling a textile is that a protective fabric layer is not required to be on both sides of the permeable membrane, thus leading to a less bulky textile laminate. The textile laminates described herein may also be lightweight, and may have a mass/area not greater than 250 g/m², not greater than 200 g/m², not greater than 175 g/m², not greater than 100 g/m², or not greater than 75 g/m².

In one embodiment, the textile laminates described herein have an outer film surface with low water pickup when compared, for example, to liquid-proof laminates having an outer textile surface. In some embodiments, the textile laminates described herein have a water pickup not greater than about 10 g/m² when tested according to the Water Pick-Up Rate Test Protocol (WPRTP). The WPRTP is based on the Bundesmann test according to DIN EN 29 865 (1993). In other embodiments, the textile laminates are formed having a water pickup of not greater than about 50 g/m², not greater than about 25 g/m², or not greater than about 20 g/m². In terms of ranges, the textile laminates are formed having a water pickup from 5 g/m² to 45 g/m², particularly from 10 g/m² to 20 g/m².

The permeable membrane according to the embodiments of the present invention may be a suitable water vapor permeable membrane. In one embodiment, the permeable membrane may comprise a monolithic membrane, in particular made from a hydrophilic polymer, such as polyurethane and/or polyether-polyester. In another embodiment, the permeable membrane may be a porous membrane, in particular made from a hydrophobic polymer, such as fluoropolymers, polyurethanes, copolyetherester, polyolefins (e.g., polypropylene and polyethylene), and polyesters are considered to be within the purview of the invention provided that the polymeric material can be processed to form porous or microporous membrane structures. In particular, expandable fluoropolymers may be used as the permeable porous membrane. Non-limiting examples of expandable fluoropolymers include, but are not limited to, expanded polytetrafluoroethylene (ePTFE), expanded modified PTFE, expanded copolymers of PTFE, fluorinated ethylene propylene (FEP), and perfluoroalkoxy copolymer resin (PFA). For example, a copolymer of ePTFE may comprise from 0.05% by weight to 0.5% by weight of comonomer units of polyfluorobutylethylene (PFBE) based upon the total polymer weight. Suitable expandable blends of PTFE, expandable modified PTFE, and expanded copolymers of PTFE have been further described in U.S. Pat. No. 5,708,044; U.S. Pat. No. 6,074,738; U.S. Pat. No. 6,541,589; U.S. Pat. No. 7,531,611; U.S. Pat. No. 8,637,144; and U.S. Pat. No. 9,139,669, the entire contents and disclosures of which are hereby incorporated by reference. It is to be appreciated that the porous membrane may be referred to as an ePTFE layer for ease of discussion. However, it is to be understood that in some embodiments any suitable porous membrane described herein may be used interchangeably with any ePTFE layer described within this application.

For example, permeable membranes suitable for the laminates may have a mass per area of not greater than 80 g/m², of not greater than 60 g/m², or of not greater than 50 g/m². It can also be desirable that the permeable membranes has a mass per area greater than about 10 g/m², or greater than 18 g/m². In some embodiments, the permeable membranes may have a mass per area from 19 g/m² and 60 g/m².

In one embodiment, the permeable membrane has pores that are sufficiently open to provide properties such as moisture vapor transmission, and air permeability. The porosity or pore volume of the permeable membrane may be from 70 to 95%. In one embodiment, the permeable membrane may be a microporous membrane.

In one embodiment, the desirable aesthetic appearance may be achieved while maintaining a substantially uniform thickness of the permeable membrane. The thickness of the permeable membrane may depend on the particular application and is generally from 10 μm to 120 μm, from 20 μm to 115 μm, or from 45 μm to 100 μm. Substantially uniform thickness refers to the thickness of the permeable membrane in the high region has being within 20%, within 10% or within 5%, of the thickness of the permeable membrane in the low region. One advantage of a substantially uniform thickness is that the permeable membrane is not deformed or strained in a manner that causes a decrease in physical properties and/or appearance on the outer surface. Unlike embossing which may lead to undesirably thin areas and non-uniform thickness, the embodiments described herein provide a substantially uniform thickness that helps to maintain the physical properties of the permeable membrane.

In some embodiments, the inner surface 104 of permeable membrane may be deformed or may be partially deformed around the high regions 112 or low regions 114 of textile 108. This causes the inner surface 104 to be distorted from the dimensionally coordinated outer surface 106. The deforming of inner surface 104 is possible provided that this deforming does not have an adverse effect on the dimensional coordination of the outer surface or the substantially uniform thickness of the permeable membrane.

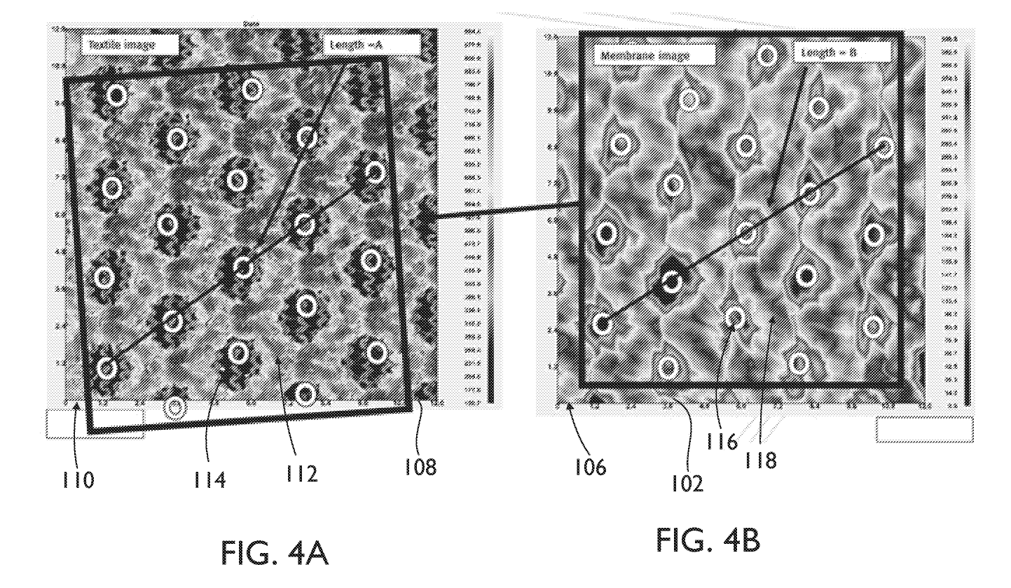

In another embodiment, the textile layer may comprise at least two permeable membranes as shown in FIG. 3. As described above, textile laminate 100 comprising a first permeable membrane 102 having an inner surface 104 and an outer surface 106, where a textile 108 is attached to the inner surface 104, and the outer surface 106 is dimensionally coordinated to the high regions and low regions. In addition, textile laminate comprises a second permeable membrane 130 attached to the textile layer 108 on a side opposite the surface 110 comprising high regions 112 and low regions 114. In one embodiment, second permeable membrane 130 may be a porous membrane, e.g., an ePFTE layer, as described herein. Without being limiting, second permeable membrane 130 may have a thickness from 0.1 μm to 200 μm.

In some embodiments, the first permeable membrane 102 may have a configuration different from the second permeable membrane 130. In particular, a laminate may be provided by having at least one of the first and second permeable membranes being waterproof. Therefore, it may be advantageous to make up the laminate using a second permeable membrane 130 being waterproof, and a first permeable membrane 102 having a lower resistance with respect to hydrostatic liquid water pressure, and hence not being considered waterproof according to the requirements of DIN EN 343 (2010). For example, the first permeable membrane may be a porous membrane, in particular made from a hydrophobic material, having a resistance with respect to hydrostatic liquid water pressure of only at least 500 Pa, particularly of at least 1000 Pa. The second permeable membrane may have the configuration of a porous membrane combined with a monolithic membrane or provided with a monolithic coating.

Further, a second textile 132 is attached to the second permeable membrane 130, thus making second permeable membrane 130 an interior layer that is not exposed to the environment. As shown in FIG. 3, second permeable membrane 130 need not be dimensionally coordinated to either of the textile 108 or 132. An interior surface 134 of second textile 132 may have a surface topology that is similar or different from surface 110. Interior surface 134 may be worn against the wearer and may be exposed to moisture from the wearer, without being exposed to the environment.

In some embodiments, the laminate may further comprise an air-impermeable polymer layer. The air-impermeable polymer layer is water-vapor permeable and transports individual water molecules across its molecular structure. This phenomenon is well known. But because of its nature, the bulk transport of liquids and gases is inhibited. The air-impermeable polymer layer is very thin and serves as support and barrier layer without impairing the visual appearance of the surface topography of the permeable membrane. The air-impermeable polymer layer can be a monolithic and/or hydrophobic coating, such as for example, a polyurethane, a copolyether, a copolyester or a silicone. Suitable air-impermeable polymer layers are further described in U.S. Pat. No. 6,074,738, the entire contents and disclosures of which are hereby incorporated by reference.

In some applications it may be desirable to add color, design, or other printed materials to the outer facing permeable membrane. Examples of adding color to an outer facing porous membrane are described in U.S. Pat. Nos. 9,006,117, 9,084,447, and 9,215,900, the entire contents and disclosures of which are hereby incorporated by reference. In one embodiment, the pores of the permeable membrane are sufficiently open to allow penetration by coatings of colorants and oleophobic compositions as described in US Pub. No. 2014/0205815, the entire content and disclosure of which is hereby incorporated by reference. In one exemplary embodiment, there may be provided a permeable membrane comprising multiple layers of asymmetric ePTFE. The asymmetric ePTFE may comprise a first ePTFE layer having an open microstructure and a second ePFTE layer having a tight microstructure. As used herein, the term “open” as opposed to “tight” means that the pore size of the “open” microstructure is larger than that of the “tight” microstructure as evidenced by bubble point or any suitable means for characterizing pore size, such as by the average fibril lengths. It is to be appreciated that a larger average fibril length indicates a more “open” microstructure (i.e., larger pore size) and a lower bubble point. Conversely, a shorter fibril length indicates a more “tight” microstructure (i.e., a smaller pore size) and a higher bubble point. Colorant coating compositions include a pigment having a particle size sufficiently small to fit within the pores of the first ePTFE layer. Pigment particles having a mean diameter of less than about 250 nanometers (nm) are useful for forming durable color. Additionally, coating compositions for use in the textile laminates typically further include a binder that is capable of wetting the ePTFE substrate and binding the pigment to the pore walls. Multiple colors may be applied using multiple pigments, or by varying the concentrations of one or more pigments, or by a combination of these techniques. Additionally, the coating composition may be applied in the form of a solid, a pattern, or a print. Application methods for colorizing fluoropolymers and other suitable polymer membrane materials such as polyurethanes are known to those that are practiced in the art and include but are not limited to, transfer coating, screen printing, gravure printing, ink-jet printing, and knife coating.

Additional treatments may be provided that impart functionality, such as but not limited to, oleophobicity and hydrophobicity, where the outer surface of the permeable membrane lacks a desired level of oleophobicity, and hydrophobicity. Examples of oleophobic coatings include for example, fluoropolymers such as fluoroacrylates and other materials such as those taught in U.S. Pub. No. 2007/0272606, the entire contents and disclosures of which are incorporated by reference. Oleophobicity can also be provided by coating at least one surface of the permeable membrane that forms the outer surface with a continuous coating of an oleophobic, moisture vapor transmissive polymer. The types of oleophobic coatings which may be used include coatings of perfluoropolyethers, acrylate or methacrylate polymers or copolymers that have fluorinated alkyl side chains.

In an optional embodiment, the permeable membrane may comprise a continuous or discontinuous coating to provide even further abrasion resistance. An abrasion resistant coating may be sprayed, coated or printed on the outer film surface. The abrasion resistant coating may comprise, for example, polyurethane, epoxy, silicone, fluoropolymers and the like, for improving abrasion resistance of the laminate. The discontinuous pattern of abrasion-resisting material may be in the form of continuous lines or grids or in the form of unconnected bodies of abrasion-resisting polymer, such as dots, chevrons, discrete lines, discrete elements or other unconnected shapes. The abrasion resistant coating may include particulates. In one embodiment, the abrasion-resisting polymeric material may cover from 30% to 80% of the outer surface of the permeable membrane, from 40% to 75% and typically from 50% to 70%. Abrasion resistance coatings are further described in U.S. Pat. No. 9,084,447, the entire contents and disclosures of which are hereby incorporated by reference.

Further, abrasion resistance coatings used on fabrics, such as those described in US Pub. No. 2010/0071115, the entire contents and disclosures of which are hereby incorporated by reference, may also be used on the permeable membranes described herein. By coating a surface of a permeable membrane with polymer dots as an abrasion-resistant resin and causing the average maximum diameter of the polymer dots to be equal to or less than 0.5 mm, the abrasion resistance of the permeable membrane can be improved without impairing the appearance of the laminate. Further, by causing the surface-coating amount of the polymer dots to range from 0.2 g/m² to 3.0 g/m², both the abrasion resistance and the light-weightness can be achieved.

Textile laminates described herein may be used, for example, in the construction of apparel such as, but not limited to, garments, shoes, tents, covers, or bivy bags. A garment may include, but not limited to, shirts, vests, coats, jackets, pants, shorts, gloves, mittens, socks, shoes, and/or hats. Items of apparel may comprise these laminates at least partially in their construction depending on the benefits, features, and performance required for each apparel item. In one embodiment, the garment may comprise the disclosed laminate in a specific region, such as but not limited to, a shoulder portion, an elbow portion, a knee portion, or a sleeve portion. In this embodiment, the remaining portion of the garment may comprise a different laminate or fabric. These regions may be also include highly visible regions where the desired aesthetic appearance are needed.

The details of one or more embodiments are set forth in the description herein. Other features, objects, and advantages will be apparent from the description and from the claims. The examples below are intended to further illustrate certain aspects of the methods and compositions described herein, and are not intended to limit the scope of the claims.

### EXAMPLES

### Test Methods

It should be understood that although certain methods and equipment are described below, any method or equipment determined suitable by one of ordinary skill in the art may be alternatively utilized.

### Liquidproof (Waterproof) Test—Suter

To determine whether a protective barrier fabric is liquidproof (e.g., waterproof), the Suter test procedure is used, which is based generally on the description in ISO 811 (1981). This procedure provides a low pressure challenge to the sample being tested by forcing water against one side of the test sample and observing the other side for indication that water has penetrated through the sample.

The sealed seam test sample is clamped and sealed between rubber gaskets in a fixture that holds the sample so that water can be applied to an area of the sample 3 inches in diameter (7.62 centimeter). The water is applied under air pressure of 1 pounds per square inch gauge (psig) (0.07 bar) to one side of the sample. In testing a fabric laminate, the water would be applied to the face or exterior side. The opposite side of the sample is observed visually for any sign of water appearing (either by wicking or the appearance of droplets) at the seam edge for 3 minutes. If no water is observed, the sample has passed the test and the sample is considered liquidproof.

### Mass Per Area

The mass per area of samples is measured according to the ASTM D 3776 (2013) (Standard Test Methods for Mass Per Unit Area (Weight) of Fabric) test method (Option C) using a suitable Scale. The scale was recalibrated prior to weighing specimens, and the weights were recorded in ounces to the nearest half ounce. This value was converted to grams per square meter (g/m²) as reported herein.

### Thickness for Membranes

To measure the thickness of the permeable membrane materials, the permeable membrane or textile laminates were placed between the two plates of a suitable calibrated snap gauge. Measurements were taken in at least four areas of each sample. The average value of these multiple measurements was reported as the thickness value for each sample.

### Moisture Vapor Transmission Rate Test (MVTR)

The moisture vapor transmission rate (MVTR) for each sample was determined in accordance with the general teachings of ISO 15496 (2004), except that the sample water vapor transmission (WVP) was converted into MVTR moisture vapor transmission rate (MVTR) based on the apparatus water vapor transmission (WVPapp) and using the following conversion.

MVTR=(Delta P value*24)/((1/WVP)+(1+WVPapp value)))

### Water Pick-Up Rate Test Protocol (WPRTP)

The WPRTP is based on the Bundesmann Test according to DIN EN 29 865 (1993) and determines the water absorption properties of textile structures using a rain test as specified in DIN EN 29865 (1993). The Bundesmann Test uses a rain unit which creates rain defined by water volume, drop size and distance of rain unit to test samples. The test runs for 10 minutes.

The rain unit comprises a droplet forming unit producing about 300 droplets of same size by respective droplet forming elements (e.g. nozzles) spread over a circular horizontally extending region covering an area of about 1300 cm² and having a diameter of 406 millimeters (mm). Each of the droplets formed should have a diameter of about 4 mm and a volume of about 0.07 milliliters (ml) when leaving the respective droplet forming element.

For performing the test, an 8 inch×8 inch (20 cm×20 cm) square sample is weighed using a calibrated scale that reads to the nearest 0.1 milligram (mg), available from Mettler Toledo of Columbus, Ohio, product item number AG104. The sample is then placed in a hydrostatic tester described in ASTM D751 “Standard Test Methods for Coated Fabrics” section 41 through 49 “Hydrostatic Resistance Procedure B” with a 4.25 inch (10.8 cm) diameter circle challenge area. The sample is placed so that the laminate surface that was designed as the outer facing surface is challenged by the water, at 0.7 pounds per square inch (psi) (48 millibar) for 5 minutes. Take care to ensure that no residual water adheres or is absorbed by the back side of the sample during placement or removal, as this will alter the reading. After exposure, the sample is removed from the tester and weighed again on the aforementioned scale. All weight gain is assumed to be from water absorbed in the challenge area of 4.25 inch (10.8 cm) diameter circle because of the high clamp pressure used to hold the sample in place. The water pickup is based on this area using the following calculation to convert to grams per square meter.

For further details of the test apparatus and test procedure, reference is made to DIN EN 29865 (1993).

### Example 1

A moisture vapor permeable, microporous polytetrafluoroethylene (PTFE) membrane was produced from PTFE resin and processed into an expanded polytetrafluoroethylene (ePTFE) membrane according to the teaching of U.S. Pat. No. 3,953,566. The ePTFE membrane had an additional oleophobic coating and an air impermeable third polymer of polyurethane as described in U.S. Pat. No. 6,074,738. The textile was a knit of a polyamide/elastane blend having a weight of 115 g/m² (Sofileta Part/article Calou: Sofileta SAS, 38311 Bourgoin-Jallieu, Cedex, France). The knit textile was laminated to the exposed ePTFE side (non-polyurethane coated side) of the ePTFE membrane by gravure printing a dot pattern of moisture curable polyurethane adhesive as described in U.S. Pat. No. 4,532,316. The adhesive printed side of the ePTFE membrane was pressed to one side of the knit textile in a nip role and then passed over a heated roll to form a 2 layer laminate. The moisture cure adhesive was allowed to cure for 48 hours.

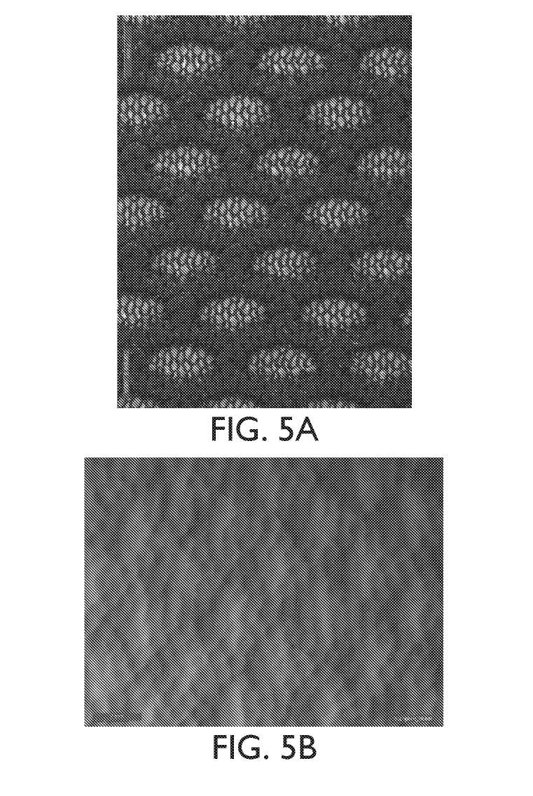

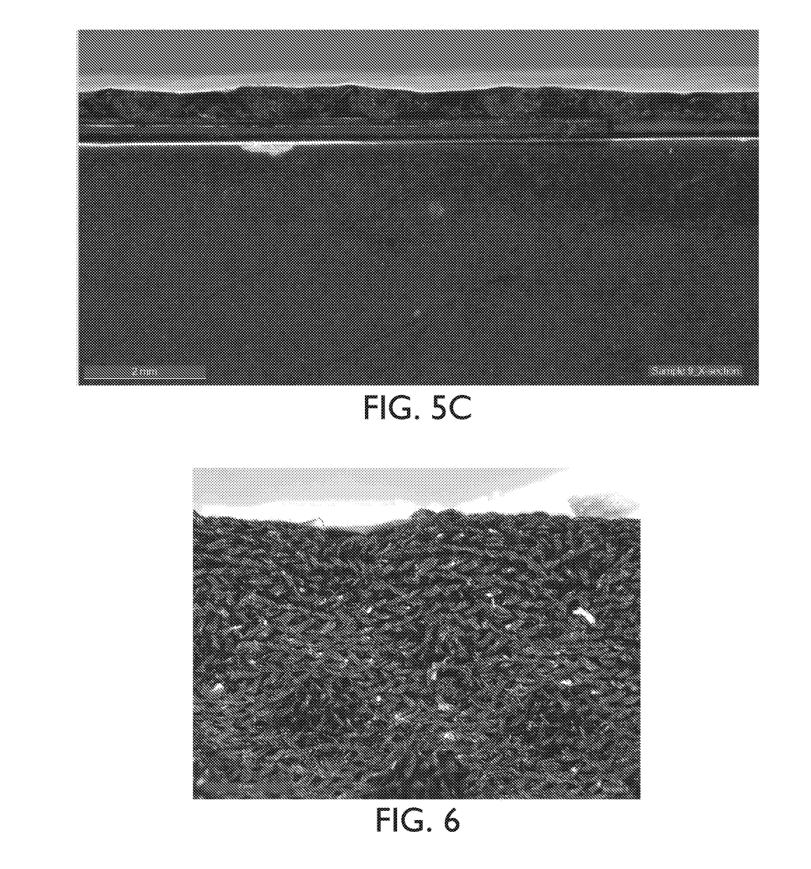

FIG. 5A is a photograph of the textile surface of the laminate according to Example 1. FIG. 5B is a photograph of the film surface of the laminate according to Example 1. FIG. 5C shows a scanning electron micrograph (SEM) cross section of the laminate according to Example 1.

### Example 2

A polyester knit textile was supplied of weight of 32 g/m² (Part No:A1012, Glen Raven Technical Fabrics LLC, Burlington N.C. 27217, USA). An ePTFE membrane was provided according to the teaching of US Pub. No. 2014/0205815. The knit textile was laminated to one side of an ePTFE membrane by gravure printing a dot pattern of moisture curable polyurethane adhesive as described in U.S. Pat. No. 4,532,316. The adhesive printed side of the ePTFE membrane was pressed to one side of the knit textile in a nip role and then passed over a heated roll to form a 2 layer laminate. The laminate was subsequently passed at low tension through an oven heat treatment process at 190° C. with a dwell time of 105 seconds.

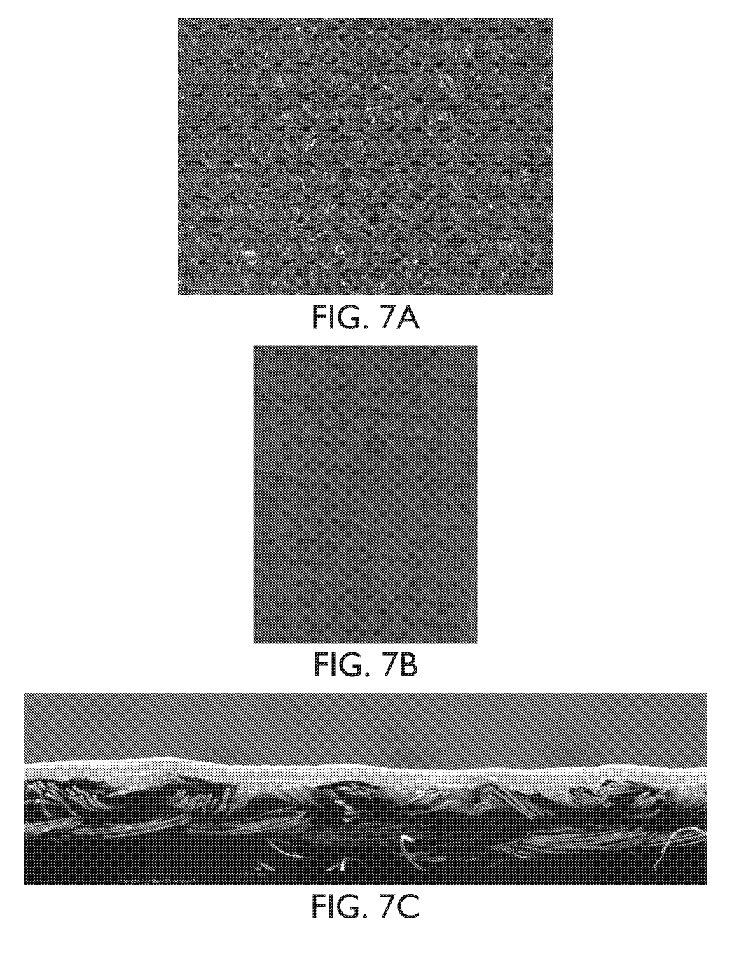

FIG. 7A is a photograph of the textile surface of the laminate according to Example 2. FIG. 7B is a photograph of the film surface of the laminate according to Example 2. FIG. 7C shows a scanning electron micrograph (SEM) cross section of the laminate according to Example 2.

### Example 3

A polyester knit textile was supplied of weight of 32 g/m² (Part No:A1012, Glen Raven Technical Fabrics LLC, Burlington N.C. 27217, USA). A polyurethane thermoplastic 25 micrometer film was obtained. (Part No. PT1710S, Covestro LLC, Fairview Way, South Deerfield, Mass. 01373 USA)

A Geo. Knight platen press was heated to 300° F. (149° C.) and the sample materials were layered under the platen from base to top as follows: 10 mm silicone rubber pad, Waxed release paper, A1012 knit with wales side uppermost, TPU PT1710S film, Waxed release paper. The heated platen was lowered to compress the layered sample and light pressure applied to the handle such the silicon rubber pad was slightly compressed for 25 seconds. The platen was then raised clear of the sample and the sample removed once cool. The waxed papers were removed and the sample retained for testing and evaluation.

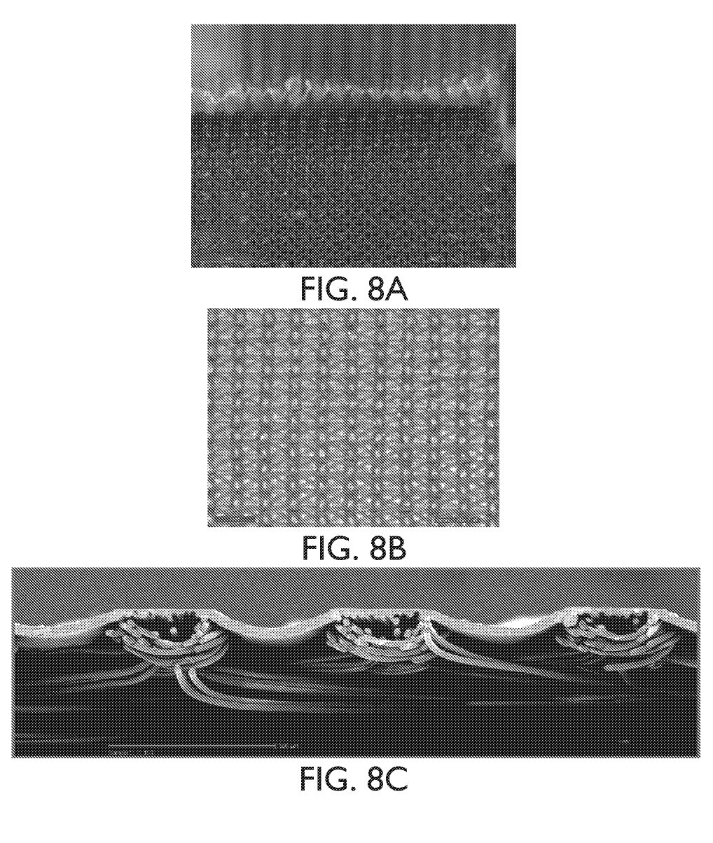

FIG. 8A is a photograph of the textile surface and film surface of the laminate according to Example 3. FIG. 8B is a photograph of the textile surface of the laminate according to Example 3. FIG. 8C shows a scanning electron micrograph (SEM) cross section of the laminate according to Example 3.

### Comparative Example A

A two layer 56 g/m² laminate is obtained made of polyamide knit and a microporous membrane of expanded polytetrafluoroethylene (ePTFE) (GORE-TEX® lifestyle liner material, Part number LNER000000, W.L.Gore and Associates (UK) Limited, Kirkton Campus Livingston, U.K.) The laminate was flexed by washing in a standard home laundry cycle followed by tumble drying at 60° C. until dry prior to examination for dimensional coordination and H/V ratio.

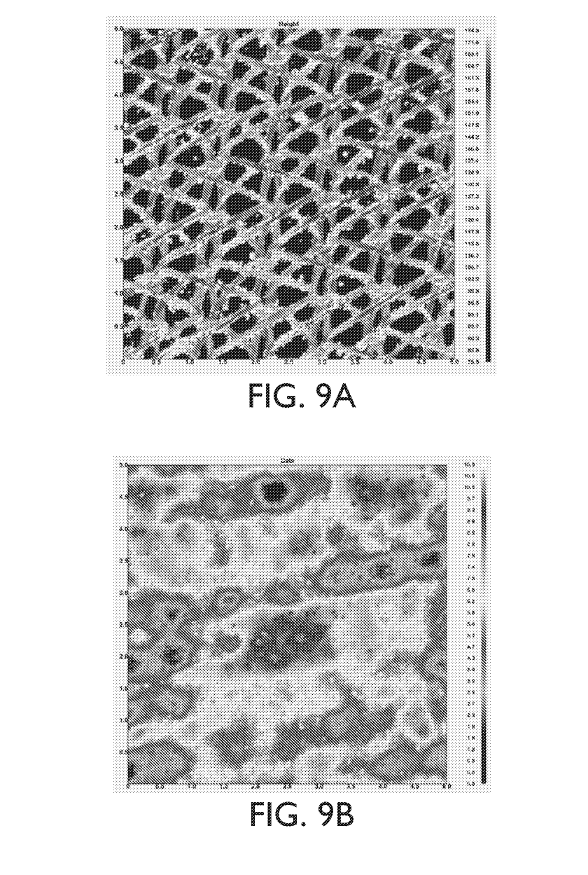

FIG. 9A is a picture of the textile surface of the laminate according to Comparative Example A as viewed with a surface measuring device. FIG. 9B is a picture of the film surface of the laminate according to Comparative Example A as viewed with a surface measuring device. As shown in FIGS. 9A and 9B and as reported in Table 1 below, the surface topography pattern of comparative example A on the membrane was observed not to be dimensionally coordinated with the underlying textile.

### Comparative Example B

A polyamide woven textile of 18 g/m² (Asahikasei Advance Inter 671) is laminated to the membrane. An ePTFE membrane was provided according to the teaching of US2014/0205815A. The woven textile was laminated to one side of an ePTFE membrane by gravure printing a dot pattern of moisture curable polyurethane adhesive as described in U.S. Pat. No. 4,532,316. The adhesive printed side of the ePTFE membrane was pressed to one side of the knit textile in a nip role and then passed over a heated roll to form a 2 layer laminate. The moisture cure adhesive was allowed to cure for 48 hours. The laminate was flexed by washing in a standard home laundry cycle at 40° C. and followed by tumble drying at 60° C. until dry.

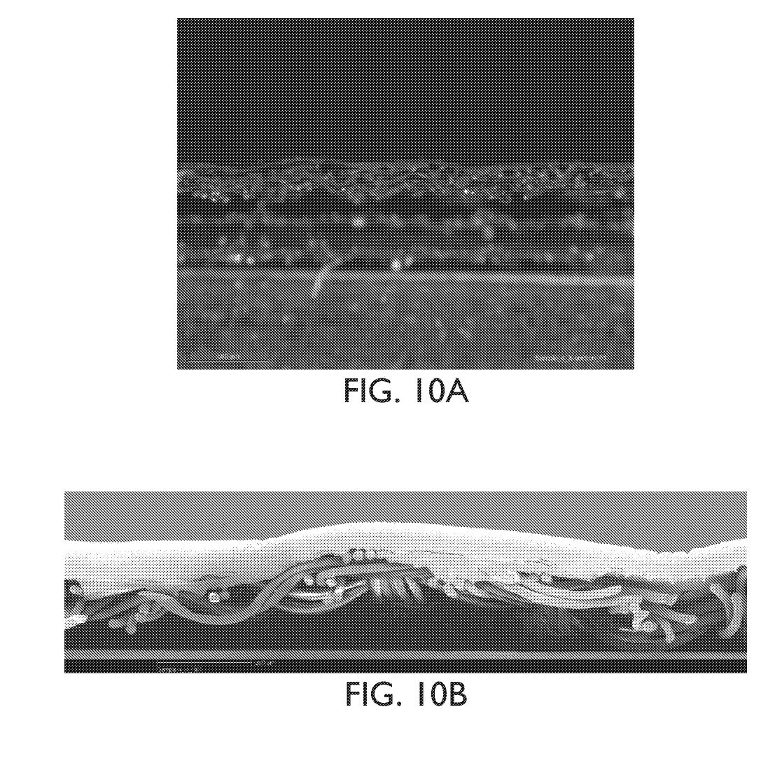

FIG. 10A is a photograph of the laminate according to comparative example B. FIG. 10B shows a scanning electron micrograph (SEM) cross section of the laminate according to comparative example B. As shown in FIGS. 10A and 10B and as reported in Table 1 below, the surface topography pattern of comparative example B on the membrane was observed not to be dimensionally coordinated with the underlying textile.

### Testing

The measurement of the MVTR, waterproofness, mass/area, thickness and according the test methods described herein is carried out on laminate samples according to the present invention and on comparative laminate samples. In addition, the average ratio of horizontal displacement to maximum vertical displacement (H/V) using a Profilometer (Nanovea ST400 STIL MG140: Nanovea, 6 Morgan Ste, Irvine, Calif. 92618, USA) was measured. The profilometer is a non-contact method of precisely measuring and displaying surface topography dimensions. A two dimensional map is produced showing vertical Z plane height differences over an X, Y surface area indicated by colored scale or a grey scale. X and Y surface area can also be imaged using reflected light intensity.

The profilometer scan is produced over an area at least 6×6 mm or greater to enable a comparison of at least 5 main features. For each main feature area (which in the case of a woven or knit textile will be a repeating feature area) on the film or membrane surface the maximum vertical displacement between highest and lowest points (peak to valley) on adjacent high and low regions within the main feature area is measured and the horizontal displacement between these two points also noted. The ratio horizontal displacement/maximum vertical displacement is the H/V ratio for that individual membrane or film surface main feature area. The individual values for each main feature area are averaged over five adjacent areas to get the average H/V ratio for that scanned area.

Dimensional coordination between the laminate membrane topography and textile topography is confirmed by examining the laminate membrane topography image and visually identifying the similar main features on at least five different adjacent locations. The Z plane height difference image is normally used but depending on the membrane surface it is also possible to get an X and Y dimensional coordination topography image using the reflected light feature of the profilometer. The spacing of the centers of the at least five adjacent main features relative to each other, are marked or imposed on the computer generated image of the laminate membrane surface.

This membrane surface spacing position image is then transposed over the textile topographic image from the profilometer and orientated for best fit of corresponding main feature center positions. The center spacing displacement of the main corresponding features of the textile surface image are compared with those on the membrane surface spacing position image at the best fit condition as follows. Straight displacement lines are drawn on the textile surface image between the centers of the at least five consecutive and adjacent main features described above, to connect the centers in a substantially straight line or a pattern as close as possible to being straight dependent on center orientation. Straight lines are then drawn on the membrane surface image between the centers of the corresponding at least five consecutive and adjacent main patterns, these lines connecting centers in a similar pattern to the at least five on the textile image. If the total displacement of the individual straight line displacements from textile and membrane images described above are within 20% then the textile and film patterns are considered to be dimensionally coordinated.

The results are shown in Table 1.

TABLE 1

| | | | Mass/ | Thick- | |
|---|---|---|---|---|---|
| | MVTR | Waterproofness | Area | ness | H/V ratio |
| Example | g/(m² 24 h) | (bar/3 min) | (g/m²) | (mm) | range |
| Example 1 | >15000 | pass | 157 | 0.37 | ~4 to 15 |
| Example 2 | ~38000 | pass | 70 | 0.20 | ~10 to 35 |
| Example 3 | ~8200 | pass | 73 | 0.19 | ~4 to 17 |
| Comp. | >20,000 | pass | 56 | 0.18 | Not |
| Ex. A | | | | | correlated |
| Comp. | ~19500 | pass | 75 | 0.22 | Not |
| Ex. B | | | | | correlated |

As indicated by Table 1, Examples 1-3 demonstrated an average H/V ratio of greater than 1 indicating that the outer surface of the membrane has a variable surface topography. Further, because Examples 1-3 meet the displacement criteria defined elsewhere within this document they are considered to be dimensionally coordinated with the pattern of high regions and low regions on the surface of the textile. In comparison, Comp. Examples A and B did not have a displacement correlation between high and low regions due to the topography of the outer surface, and thus the outer surface of Comp. Examples A and B were not dimensionally coordinated.

When examining larger surface areas, such as garments, for practical reasons dimensional coordination is judged over a sampled area as follows. A sample area of 100 mm×100 mm is randomly selected within the area of interest on the textile laminate or garment. Within this sample area, three further small areas of 6×6 mm or greater are randomly selected and a profilometer scan is produced over each as described above. If dimensional coordination of the textile and laminate membrane images for all three small areas is established according to the above definition, then the garment or textile laminate is considered to be dimensionally coordinated.

The compositions of the appended claims are not limited in scope by the specific compositions described herein, which are intended as illustrations of a few aspects of the claims and any compositions that are functionally equivalent are within the scope of this disclosure. Various modifications of the compositions in addition to those shown and described herein are intended to fall within the scope of the appended claims. Further, while only certain representative compositions and aspects of these compositions are specifically described, other compositions are intended to fall within the scope of the appended claims. Thus a combination of steps, elements, components, or constituents may be explicitly mentioned herein; however, all other combinations of steps, elements, components, and constituents are included, even though not explicitly stated. All publications, patents, and patent applications cited herein are hereby incorporated by reference in their entireties for all purposes.

1. A textile laminate, comprising:
a water vapor permeable outward facing protective membrane comprising an inner surface and an outer surface; and
a textile attached to the inner surface of the permeable membrane, wherein the textile has a surface having a pattern of high regions and low regions wherein the textile comprises a woven, or knit material,
wherein the outer surface of the permeable membrane has a surface topography that is dimensionally coordinated with the pattern of high regions and low regions on the surface of the textile, and
wherein said dimensional coordination occurs with an H/V ratio of greater than or equal to 0.5, wherein the H/V ratio is defined by the horizontal displacement (H) between adjacent high and low regions to the vertical displacement (V) between a peak in the high region and a valley in the adjacent low region on the outer surface of the permeable membrane.

2. The laminate of claim 1, wherein said dimensional coordination further occurs with an H/V ratio of greater than or equal to 1.

3. The laminate of claim 1, wherein said dimensional coordination further occurs with an H/V ratio from 1 to 100.

4. The laminate of claim 1, wherein the total of the individual straight line displacements from the outer surface of the permeable membrane is within 20% of the total of the individual straight line displacements on the surface of the textile.

5. The laminate of claim 1, wherein the vertical displacement of high region to adjacent low region on the outer surface of the permeable membrane is from 10 to 600 micrometers.

6. The laminate of claim 1, wherein the surface topography comprises a repeating pattern.

7. The laminate of claim 1, wherein at least part of the inner surface of the permeable membrane is deformed around at least one of the high regions or low regions of the textile.

8. The laminate of claim 1, wherein the permeable membrane is not embossed.

9. The laminate of claim 1, wherein the permeable membrane has a substantially uniform thickness.

10. (canceled)

11. The laminate of claim 1, wherein the permeable membrane further comprises a colorant.

12. The laminate of claim 1, wherein the permeable membrane further comprises an abrasion resistant coating.

13. The laminate of claim 1, wherein the outer surface of the permeable membrane is provided with an additional monolithic and/or hydrophobic coating on the outer surface.

14. The laminate of claim 1, wherein the permeable membrane comprises a porous membrane.

15. The laminate of claim 14, wherein the porous membrane is polytetrafluoroethylene, expanded polytetrafluoroethylene, polyurethane, copolyetherester, polyolefins, polyesters, or a combination thereof.

16. The laminate of claim 1, wherein the permeable membrane comprises a monolithic membrane.

17. The laminate of claim 16, wherein the monolithic membrane is a polyurethane, polyether-polyester, or a combination thereof.

18. A garment comprising the textile laminate of claim 1.

19. The garment of claim 18, wherein the garment is selected from the group consisting of shirts, pants, gloves, shoes, hats, and jackets.

20. The garment of claim 18, wherein the outer surface forms the outermost side of the garment exposed to the environment.

21. The garment of claim 18, wherein the garment comprises at least one region constructed of the textile laminate.

22. The garment of claim 21, wherein the at least one region is a shoulder portion, an elbow portion, a knee portion, or a sleeve portion.
